(19) United States
(12) Patent Application Publication
(10) Pub. No.: US 2002/0107714 A1
(43) Pub. Date: Aug. 8, 2002

(54) Method and system fo transferring connecting baggage

(76) Inventors: Steve Alexander Whitlock, Atlanta, GA (US); Irina Ioachim, Marietta, GA (US); Patrick Carl Rary, Marietta, GA (US)

Correspondence Address: KING & SPALDING, 191 PEACHTREE STREET, N.E., ATLANTA, GA, 30303-1763, US

(21) Appl. No.: 09/778,220

(22) Filed: Feb. 6, 2001

(51) Int. Cl. G06F 17/60

(52) U.S. Cl. 705/8

(57) ABSTRACT

Using a distributed computer network to support efficient transfer of baggage from inbound aircraft to connecting aircraft. The network comprises a server computer logically connected to databases maintained by the carrier and containing passengers' itineraries and their baggage information. Also connected to the network are dispatch clients, responsible for managing the transfer of baggage, and tug clients, responsible for managing delivery of baggage from the inbound flight to the connecting flights. When an inbound flight is approaching a typical hub airport, a software module operating on the server computer retrieves data for passengers with connecting flights and their baggage. The software module uses this data to evaluate various combinations of assignments and routes for transferring the baggage and determines which is the most efficient solution. The dispatch client then obtains and distributes the assignments and routes to the tug clients. The tug clients manage the transfer of baggage from inbound flights to connecting flights according to the assignments and routes formulated by the software module running in the distributed computer network.

### TECHNICAL FIELD

The present invention generally relates to transferring baggage from an inbound flight to one or more connecting flights in a hub airport environment. More specifically, it allows baggage to be loaded onto connecting flights more quickly and efficiently.

### BACKGROUND OF THE INVENTION

Airplane travel is becoming an increasingly popular means of travel for people today. This popularity has caused the number of airplane travelers to increase dramatically and a corresponding increase in the volume of baggage the air carriers must handle. The greater volume of baggage creates more work for carriers and can cause delays in flight schedules.

The baggage problem is particularly acute at hub airports where travelers arriving on inbound flights are transferring to connecting flights. Typically, many of the travelers on an inbound flight transfer to various connecting flights. As these travelers transfer to their respective connecting flights, the carrier must also transfer each traveler's baggage to the correct connecting flight.

Airlines need efficient ways to quickly and accurately move baggage from inbound flights to connecting flights. The conventional approach uses a dispatcher to organize and manage a pool of tug drivers. The dispatcher manually gives tug drivers assignments that direct where to pick up inbound bags and to which connecting flights they must be delivered.

For example, as inbound flights are approaching an airport, the dispatcher receives information about the inbound flight's gate assignment, the connecting baggage on the flight, and the gates to which the connecting baggage must be delivered. The gates are grouped into zones based on their proximity to each other. The dispatcher then relies on her experience to create the quickest and most efficient assignments and routes for the tug drivers on paper. The written assignments are distributed to the tug drivers. Each tug driver is assigned one or more zones to which they will deliver connecting bags. The tug driver's route for completing the assignment is typically created by starting with any connections that are departing shortly after the inbound arrival. Once the baggage for close connections is delivered, the driver proceeds sequentially to the remaining gates in the assignment. After completing an assignment, each tug driver returns to the dispatcher for a new assignment and route.

There are several drawbacks with the conventional approach to transferring baggage. First, in order to create efficient assignments and routes, there are several variables a dispatcher must consider. The variables include the number of tug drivers to use, the number of bags each tug driver should have, the number of stops each tug driver has to make, and the number and location of the zones each tug driver has to cover. Given the number of variables involved, it is difficult and time-consuming for a dispatcher to calculate all of the possible combinations in order to find the most efficient solution of assignments.

A second drawback is that the information a dispatcher relies on often changes after the assignments and routes are created or while the tug drivers are out completing their assignments. New information can include different gate assignments for the inbound or connecting flights and unassigned baggage checked belatedly at the gate.

Finally, once the tug driver completes an assignment, she must make an “empty ride” without any baggage back to the dispatcher to receive a new assignment. The return trip to the dispatcher is wasted time that could be used completing another assignment.

Accordingly, there is a need in the art for a method and system which will enable carriers to transfer baggage to connecting flights quickly, efficiently, and accurately. In other words, there is a need to automate the assignment and routing of transferring baggage so that numerous variables can be considered and the best of all possible combinations of assignments can be selected. There is also a need for tug drivers to receive updates to assignments and routes when there are changes in information concerning gate assignments or belatedly checked baggage. There is a further need to communicate new assignments to tug drivers once an assignment is complete.

### SUMMARY OF THE INVENTION

The present invention is an electronic dispatch system that improves upon existing methods for transferring baggage from inbound flights to connecting flights. The system comprises a distributed computing environment typically maintained by the carrier and accessed by dispatch clients and tug clients. The dispatch client initiates the baggage transfer process by accessing a software module running on a server in the distributed computing environment. The dispatch client typically begins the process before an inbound flight arrives at the airport. The software module can collect a variety of data from other computers and databases in the distributed computing environment. This data can include information about the inbound flight, the passengers, the passengers' connecting flights, and the passengers' baggage.

The software module formulates the most efficient assignments and routes for delivering the baggage to the connecting flights. For example, the software module can begin by assembling the various combinations of assignments and calculating a corresponding cost for each assignment. The cost can be calculated by considering variables such as the number of tug drivers, the number of stops a driver must make, and the number of bags a driver must transfer. Once the most efficient assignment is identified, the best route for completing the assignment will be calculated. Different routes can be created by varying the sequence of the stops in the assignment. The best route is the one where the least distance must be traversed by the tug driver. Once the assignments and routes are constructed, the dispatch client can distribute them to tug clients. The tug clients can notify the dispatch client when an assignment is complete and the baggage handlers are ready for another assignment.

Existing dispatch systems do not allow for quick and efficient transfer of baggage from an inbound flight to connecting flights. The conventional approach is to have dispatchers create routes and assignments by hand based on connecting flight information and their experience in baggage management. In contrast, the present invention allows a dispatcher to use a software module operating on a server to analyze information about the flights and to determine the most efficient routes and assignments for delivering baggage. The present invention permits continuous updating of the data on which the routes and assignments are based. Tug drivers can have current information about flight or gate changes and do not need to return to the dispatcher to receive new assignments.

### BRIEF DESCRIPTION OF THE DRAWINGS

FIG. 1 is a functional block diagram illustrating the architecture and components of an exemplary embodiment of the present invention.

FIG. 2 is a logic flow diagram illustrating operations of an electronic dispatch system constructed in accordance with an exemplary embodiment of the present invention.

FIG. 3 is a logic flow diagram illustrating an exemplary process for retrieving flight data information for formulating baggage assignments and routes.

FIG. 4 is a block diagram illustrating the gates and baggage zones at a typical hub airport.

FIG. 5 is a logic flow diagram illustrating an exemplary process for formulating an assignment solution.

FIG. 6 is a tree diagram illustrating the combinations in a representative assignment solution calculation.

FIG. 7 is a logic flow diagram illustrating an exemplary process for formulating a routing solution.

FIG. 8 is a tree diagram illustrating the combinations in a representative routing solution calculation.

FIG. 9 is a logic flow diagram illustrating an exemplary process for delivering baggage according to the best assignment and routing solution.

FIG. 10 is a logic flow diagram illustrating an exemplary process for calculating the cost of an assignment.

### DETAILED DESCRIPTION OF THE EXEMPLARY EMBODIMENTS

The present invention supports the transfer of baggage from inbound flights to connecting flights. This is accomplished through the use of a distributed computing environment operated by or on behalf of the carrier. As an inbound flight is approaching, a dispatch client communicates the inbound flight number to an electronic dispatch software module operating on a server computer. The electronic dispatch software module communicates with other computer systems maintained by the carrier and retrieves passenger and baggage information for the inbound flight. Using the passenger and baggage information, the electronic dispatch software module formulates the most efficient assignments and routes for drivers to deliver baggage to connecting flights. A dispatcher then electronically forwards individual assignments with their corresponding routes to the drivers. While delivering the connecting bags, the drivers can receive continuous updates of any changes in flight or gate information.

Although the exemplary embodiments include general descriptions of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks, enterprise-wide computer networks, and the global Internet.

The detailed description which follows is represented largely in terms of processes and symbolic representations of operations in a distributed computing environment by conventional computer components, including memory storage devices, server and client computers, output devices and input devices. Each of these conventional distributed computing components is accessible via a communications network.

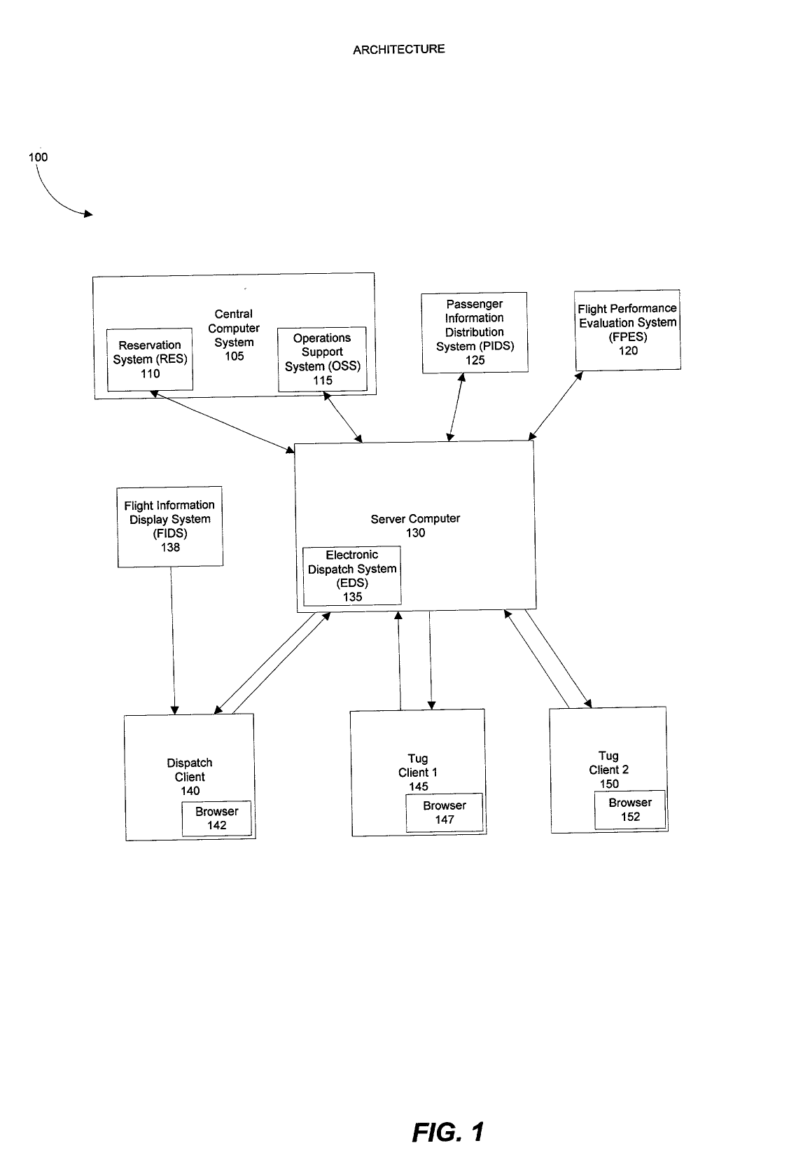

Referring now to the drawings, in which like numerals represent like elements throughout the several figures, aspects of the present invention and the preferred operating environment will be described. FIG. 1 illustrates various aspects of an exemplary computing environment in which the present invention is designed to operate. Those skilled in the art will appreciate that FIG. 1 and the associated discussion are intended to provide a brief, general description of the preferred computer hardware and program modules, and that additional information is readily available in the appropriate programming manuals, user's guides, and similar publications.

With reference to FIG. 1, an exemplary system for implementing the invention includes a distributed computing environment 100 comprising a central computer system 105, a server computer 130, a dispatch client 140, and tug clients 145 and 150. The dispatch client 140 initiates the process when it learns of an inbound flight from the flight information display system (FIDS) 138. Typically, a person operating the dispatch client 140 will receive inbound flight information by viewing a video screen connected to the FIDS 138. A browser 142 residing on the dispatch client 140 communicates the inbound flight number to the electronic dispatch system (EDS) software module 135 residing on the server computer 130. The dispatch client 140 and server computer 130 may communicate via a cable capable of transmitting electrical signals or via a wireless connection.

The EDS software module 135 compiles the passenger and baggage data for the inbound flight in order to create assignments and routes for baggage delivery to connecting flights. The EDS may retrieve passenger and baggage data from the passenger information distribution system (PIDS) 125 and connecting flight data from the flight performance evaluation system (FPES) 120. Alternatively, this information may also be retrieved from the reservation system (RES) 110 and the operations support system (OSS) 115, both of which reside on the central computer system 105.

Once the passenger, baggage, and connecting flight data are retrieved, the EDS software module 135 creates baggage delivery assignments and routes for completion by tug drivers. The dispatch client 140, using the browser 142, distributes the assignments and routes to tug clients 145 and 150. Typically, a tug client comprises a computing device mounted on a motorized tug and operated by a tug driver. The tug clients 145 and 150 communicate with the server computer 130 via a wireless connection. The tug client 145 can continuously receive accurate information about flight and gate changes.

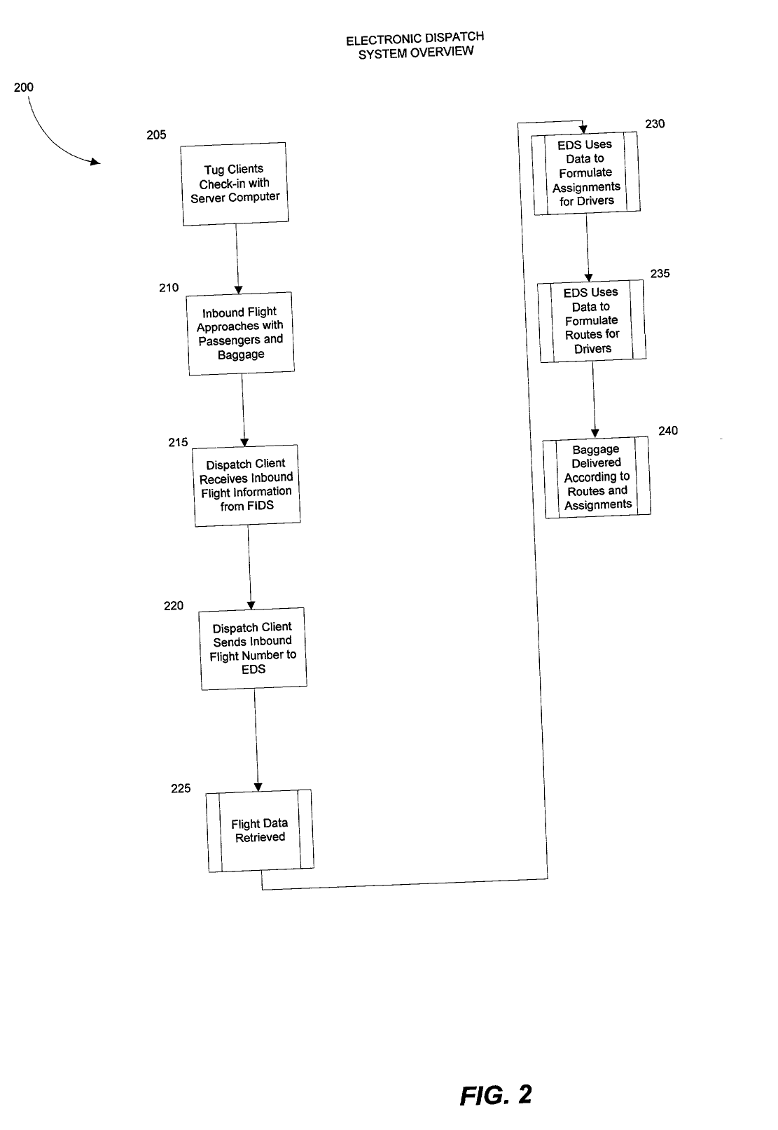

FIG. 2 is a logic flow diagram illustrating an overview of the operations completed by the exemplary electronic dispatch system 200. Beginning with step 205, tug clients 145 and 150 will check-in with the server computer 130. This step lets the server computer 130 know how many tug clients are available for transferring baggage. As an inbound flight approaches in step 210, the dispatch client 140 receives the inbound flight number from the FIDS 138 in step 215. The dispatch client 140 sends the inbound flight number to the EDS software module 135 residing on the server computer 130 in step 220. Transmitting the flight number from the dispatch client 140 to the server computer 130 is typically accomplished with a browser software module 142 residing on the dispatch client 140.

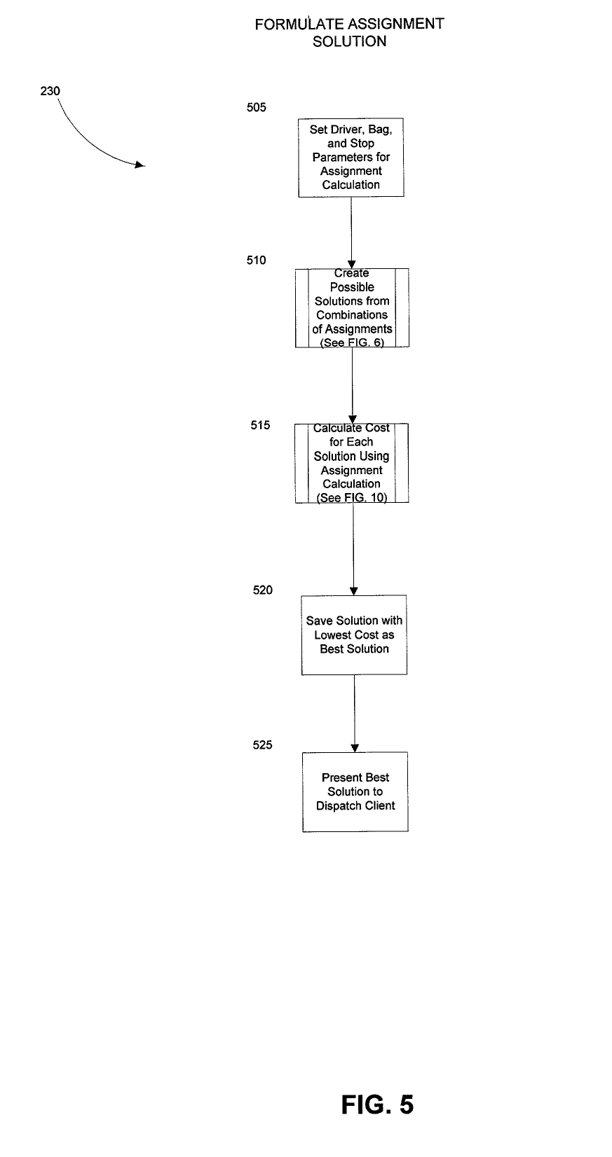

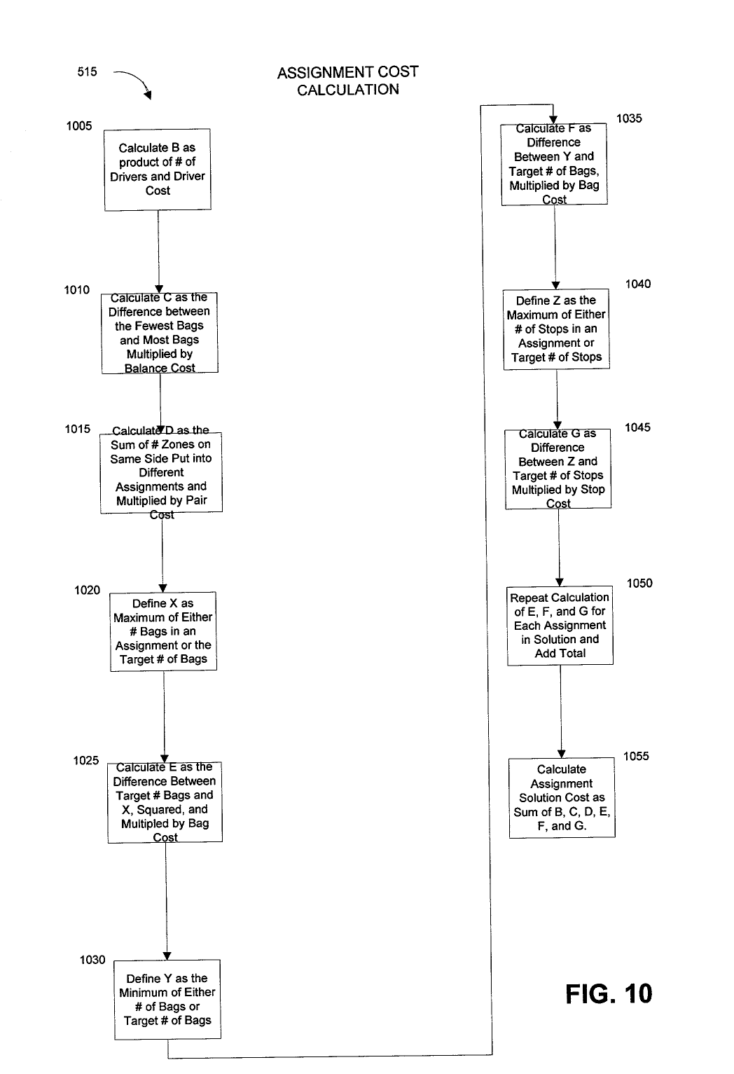

In step 225, the EDS software module 135 retrieves the flight, passenger, and baggage data from databases maintained by the carrier. This data is utilized by the EDS software module 135 to formulate assignments and routes for the transfer of baggage in steps 230 and 235. The EDS software module 135 calculates the assignments according to a formula, which is described in greater detail below in conjunction with FIGS. 5 and 10. The formula involves several variables including the number of drivers, the number of bags each driver is assigned, and the number of stops each driver will make. Each variable is given a weighting factor which can be used to emphasize one variable over another and to tailor the assignment solution as desired for the airport environment. In step 240, the tug drivers transfer baggage from the inbound flight to the connecting flights according to the routes and assignments they receive.

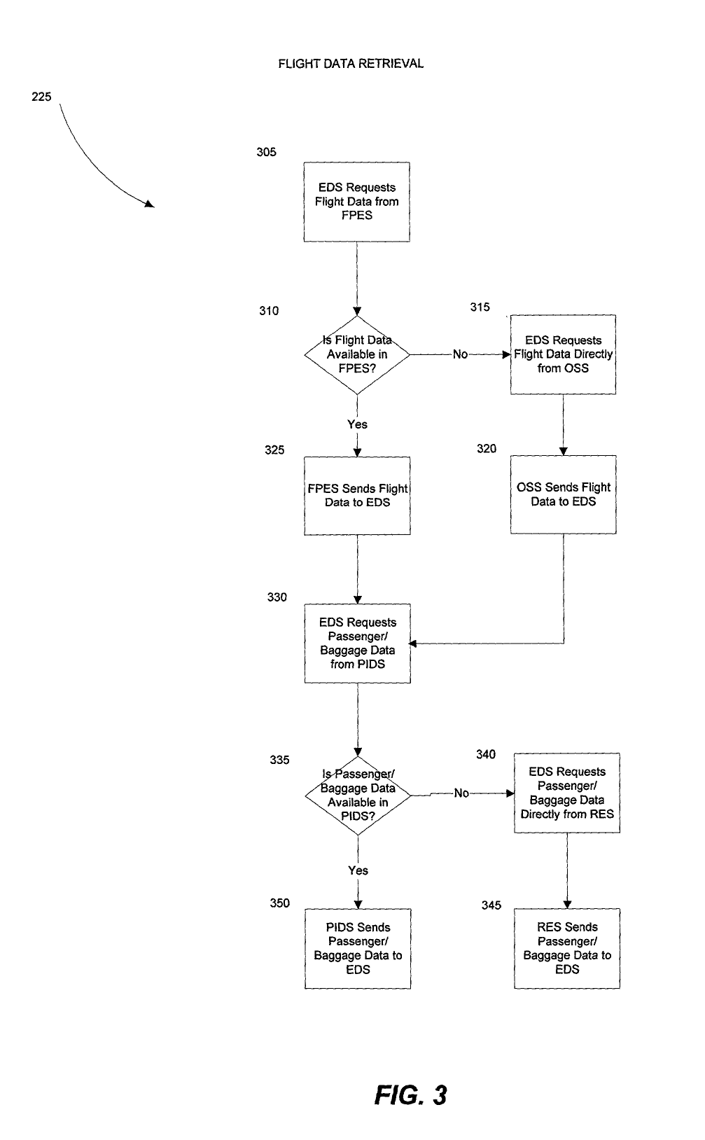

FIG. 3 is a logic flow diagram setting forth in greater detail the exemplary data retrieval process represented in step 225. Beginning with step 305, an interface within the EDS software module 135 requests connecting flight data from the FPES. In step 310, if the data is available in FPES 120, the “Yes” branch is followed to step 325 and the flight data is sent to the EDS software module 135. If the flight data is not available in FPES 120, the “No” branch is followed to step 315 where the EDS software module 135 requests the flight data from the OSS 115 residing on the central computer system 105. In step 320 the OSS 115 sends the flight data to the EDS software module 135.

In step 330 an interface within the EDS software module 135 requests the passenger and baggage data for the inbound flight from the PIDS 125. In step 335, if the data is available in PIDS 125, then the “Yes” branch is followed from step 335 to step 350 and the passenger and baggage data is sent to the EDS software module 135. If the flight data is not available in PIDS, the “No” branch is followed to step 340 where the EDS software module 135 requests the passenger and baggage information from the RES located on the Central Computer System 105. The RES sends the passenger and baggage information to the EDS software module in step 345.

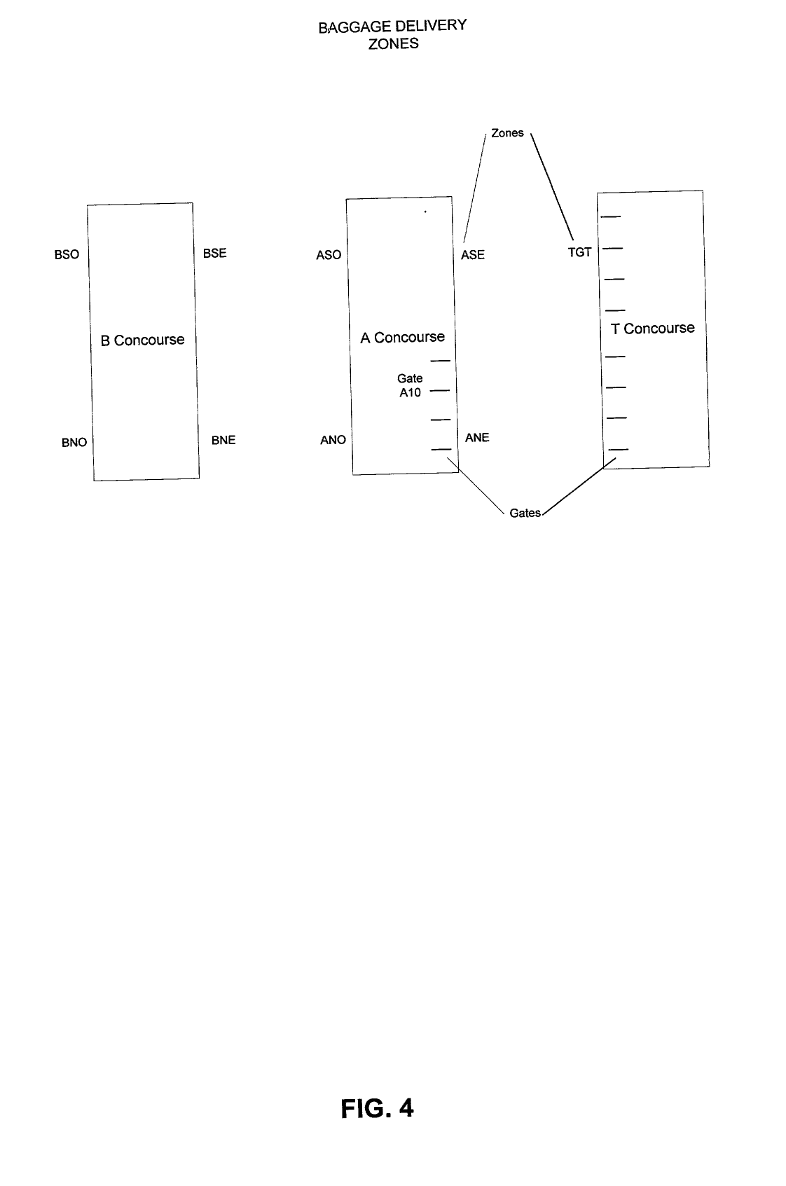

FIG. 4 is a block diagram illustrating a typical arrangement of gates at a hub airport. The gates are grouped into zones and each zone is named. These zones will be used in the subsequent diagrams to illustrate how assignments and routes are created. Typically, the gate where the inbound flight is located is the starting point for all assignments because this is where the tug drivers pick up the baggage that is to be transferred to connecting flights. Alternatively, the starting point may be a gate with a connecting flight that is departing shortly after the inbound flight arrives. A zone may have none, one, or several gates with connecting flights that will receive baggage from the inbound flight. The zones are grouped together based on proximity to form assignments. The number of zones in an assignment will vary depending on the number of connecting flights within the zone and the number of bags for each connecting flight. In alternative embodiments of the invention the gates may be arranged in other patterns which will affect how they are grouped in order to create efficient assignments and routes.

FIG. 5 is a logic flow diagram illustrating how the exemplary EDS software module 135 creates an assignment solution. FIG. 5 elaborates on the assignment algorithm represented in step 230. An assignment solution comprises one or more assignments necessary to transfer the baggage from an inbound flight to connecting flights. Each assignment solution can be described as having a numerical cost, the most efficient solution having the lowest cost. The formula for computing the cost of an assignment solution may consider several variables including the number of drivers, the number of bags assigned to each driver, the number of stops in a driver's assignment, and the number of zones a driver must cover. The following formula is used in the present invention, although alternative embodiments of the invention may comprise formulas including other variables such as time, the size of the bags, or the size of the tug.

Cost=

(number of drivers)*(driver cost)+

max(num. bags)−min(num bags))*(balance cost)+

(num. same side zones not kept together)*(balance cost)÷

Σassignments (max(num. of bags, target num. of bags)−((target num. of bags))**2*(bag cost)+

(target num. of bags−min(num. bags, target num. of bags))*(bag cost)+(max(target num. of stops, num. of stops) - target num. of stops)*(stop cost)

In step 505 the parameters for the numbers of drivers, bags, zones, and stops are set. These parameters include a “driver cost” which is a weighting factor for the number of drivers used in the assignment solution. The “bag cost” and “stop cost” are weighting factors multiplied with the difference between the target and actual numbers of bags and stops. The “pair cost” is a weighting factor multiplied with the number of instances adjacent zones on the same side of a concourse are not grouped together in the same assignment. The “balance cost” is a factor multiplied with the greatest difference in the number of bags between two assignments in the solution. Limits on the numbers of bags and stops can also be set at this time. The ultimate goal in creating the assignment solution can vary and may include minimizing the number of drivers or evenly distributing the baggage. Nonetheless, the desired efficiency can be achieved by manipulating the values of the weighting factors and the limits.

In step 510, the EDS software module 135 assembles the possible combinations of zones into assignments in order to create the possible assignment solutions. Using the formula set forth above, the EDS software module calculates the cost for each solution in step 515. If the maximum limits for the number of bags and stops is exceeded while a potential solution is being created, that solution will be abandoned and another combination will be begun. In step 520, the assignment solution with the lowest cost, as determined by the above cost formula, is saved as the best solution. The best solution will vary depending on which variables are considered the most important and given the greatest weighting factor. The server computer 130 presents the best assignment solution to the dispatch client 140 via the browser 142 in step 525.

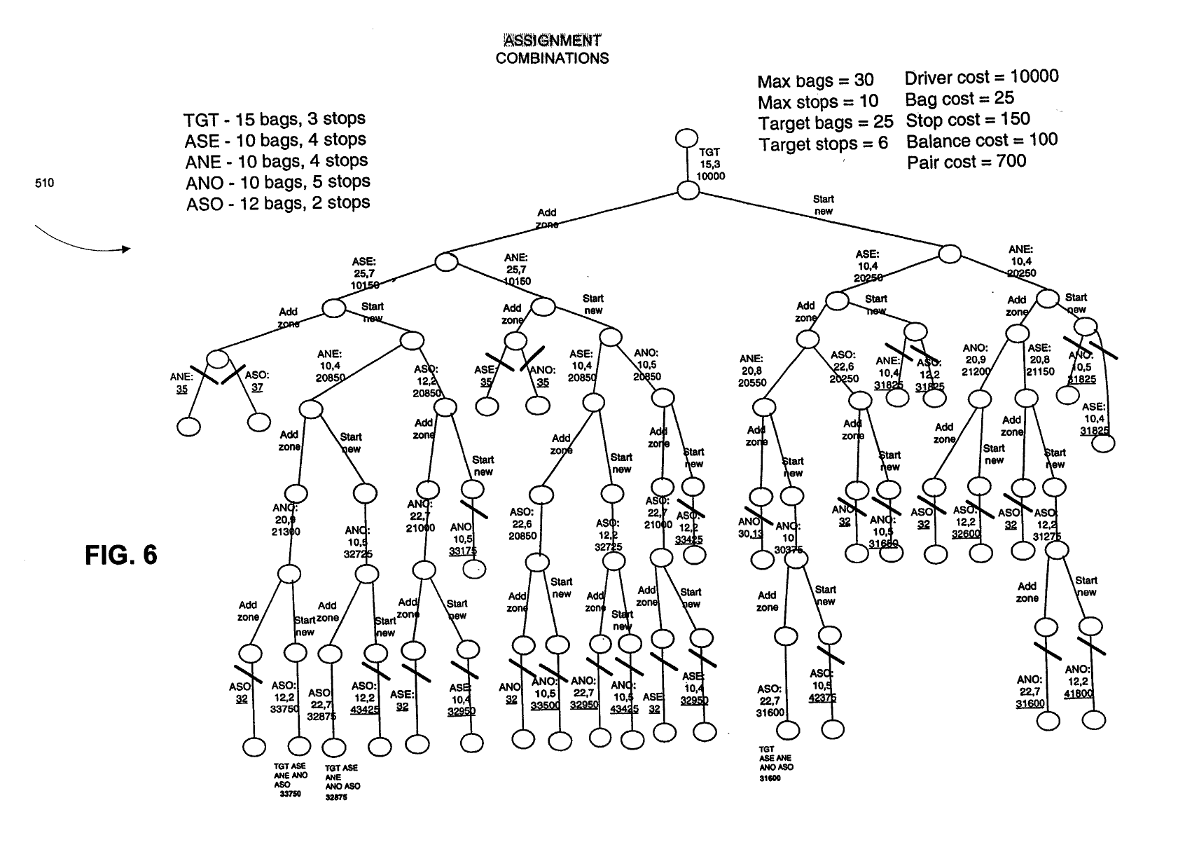

FIG. 6 is a tree diagram representing the combinations of potential assignments that are created by the EDS software module 135. The particular example set forth in FIG. 6 comprises 5 zones, each with a certain number of stops and bags. Typical values for the parameters were selected and used in the assignment formula. The diagram begins at the TGT zone and at that point has 15 bags, 3 stops and a cost of 10,000 as computed by the assignment formula. Taking the left branch first, the ASE zone is added to the assignment with TGT yielding 25 bags, 7 stops, and a cost of 10,150. Attempting to add either of the adjacent zones, ASO or ANE, to the assignment results in baggage counts of 37 and 35 respectively. As the maximum number of bags was set at 30, the assignment algorithm does not add the ASO or ANE zones and instead, takes the right branch and starts a new assignment.

Taking the left branch at this point, the new assignment starts with the ANE zone which has 10 bags, 4 stops, and a cost of 20,850. Adding the ANO zone to this assignment produces an assignment with 20 bags, 9 stops, and a cost of 21,300. Attempting to add the final zone, ASO, to this assignment yields 32 bags which violates the maximum. Alternatively, a new assignment with only the ASO zone can be created. This produces an assignment solution of three assignments. The first assignment comprises the TGT and ASE zones. The second assignment comprises the ANE and ANO zones. The third assignment comprises the ASO zone. The total cost for this assignment solution is 33,750.

The EDS software module 135 proceeds with the remaining combinations of zones as set forth in FIG. 6. After attempting all of the combinations, the most efficient assignment solution, as calculated by the assignment formula, is identified. Other examples may have different parameters or more connecting flights. As the number of connecting flights increases, there is generally a corresponding increase in the number of zones and an increased number of combinations of assignments.

FIG. 10 is a logic flow diagram illustrating the cost calculation for an assignment solution as set out in the formula above and as represented in step 515. This formula is an exemplary embodiment of a cost calculation for the present invention. Alternative embodiments of the invention may apply different weighting factors or include variables describing other aspects of the process such as time, the size of the bags, or the size of the tug. In step 1005, the product of the number of drivers and the driver cost is stored as the variable B. The relative importance of the number of drivers in the formula is adjusted by altering the driver cost. In step 1010, C is the difference between the assignment with the fewest bags and the assignment with the most bags, multiplied by the balance cost. The balance cost factor emphasizes an even distribution of bags in each assignment of the assignment solution. In step 1015, D is the sum of the number of zones that are separated onto different assignments, multiplied by the pair cost. The effect of the pair cost factor is to minimize the separation of zones on the same side of a concourse as this separation is viewed as an undesirable inefficiency.

Steps 1020 through 1045 will be repeated for each assignment in the assignment solution. In step 1020, X is equal to either the number of bags in an assignment or the target number of bags, whichever is larger. In step 1025, the target number of bags is subtracted from X, that number is squared and then multiplied by the bag cost to produce E. In step 1030, Y equals the smaller of either the number of bags in the assignment or the target number of bags. F, in step 1035, equals the difference between Y and the target number of bags, multiplied by the bag cost. The E and F variables address the divergence of the bag count in each assignment from the target bag number. In step 1040, Z is the larger of either the number of stops in an assignment or the target number of stops. In step 1045, G is computed by subtracting Z from the target number of stops and multiplying the difference by the stop cost. Steps 1020 and 1025, 1030 and 1035, and 1040 and 1045 are repeated for each assignment in the assignment solution and those results are summed in step 1050. In step 1055, the results of steps 1005 (B), 1010 (C), 1015 (D), and 1050 (E, F, and G for all assignments in the solution) are summed to produce the cost for the assignment solution. The formula set forth above, but with the foregoing variables substituted in place of the terms, looks as follows:

Cost=

B+

C+

D+

Σassignments (X−(target num. of bags))**2*(bag cost)+

(target num. of bags−Y)*(bag cost)+(Z−target num. of stops)*(stop cost)

Substituting further:

Cost=

B+

C+

D+

Σassignments E+

F+

G

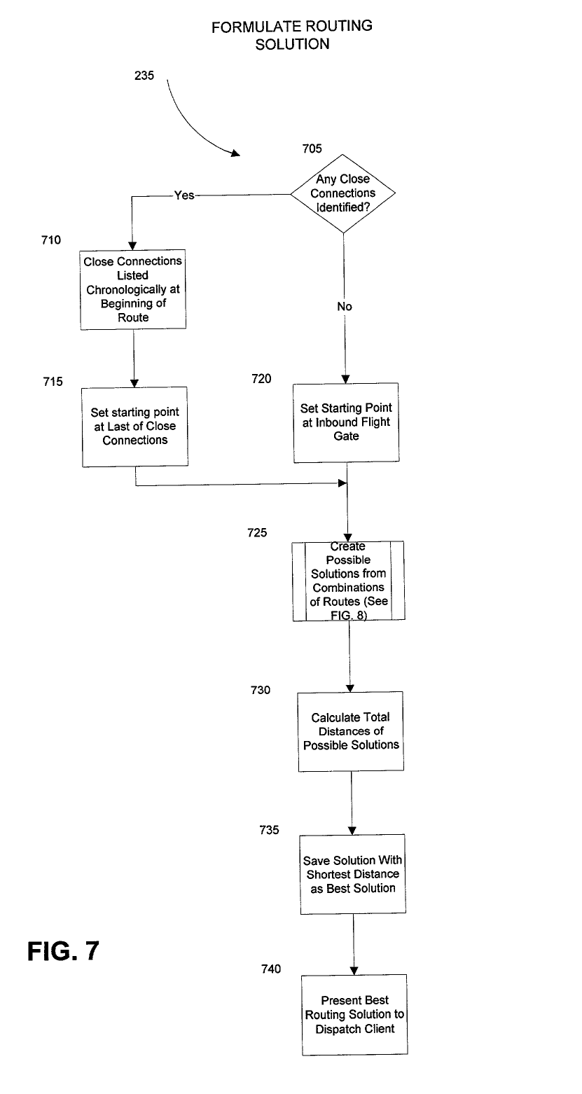

Referring to FIG. 7, once the assignment solution is identified, a routing solution can be created for each assignment within the solution. FIG. 7 elaborates on the formulation of a routing solution as represented in step 235. The process begins at step 705 where any close connections are identified. Typically, a close connection is defined as any connecting flight leaving within a half hour of the arrival of the inbound flight. However, this time frame can be adjusted by the carrier. If there are close connections, the “Yes” branch is followed to step 710 where the route begins with all close connections in the assignment. The close connections are routed in the order that they are departing and, in step 715, the last of these become the starting point for the remaining connections in the assignment. If there are no close connections in the assignment, the “No” branch is followed to step 720 where the starting point for the route is set at the inbound flight gate, in this example Gate A10.

In step 725, the routing algorithm creates different combinations of routes from the remaining connecting stops listed in the assignment. In step 730, for each possible route, the routing algorithm calculates the distance the tug driver would cover to reach each stop on the route. The distance between gates is calculated from a coordinate system in which each gate is assigned an x and y coordinate to locate its physical position. The routing solution with the shortest total distance to cover is saved as the best solution in step 735. A routing solution is created for each assignment in the assignment solution. In step 740, the best routing solution is presented to the dispatch client 140 on the server computer 130.

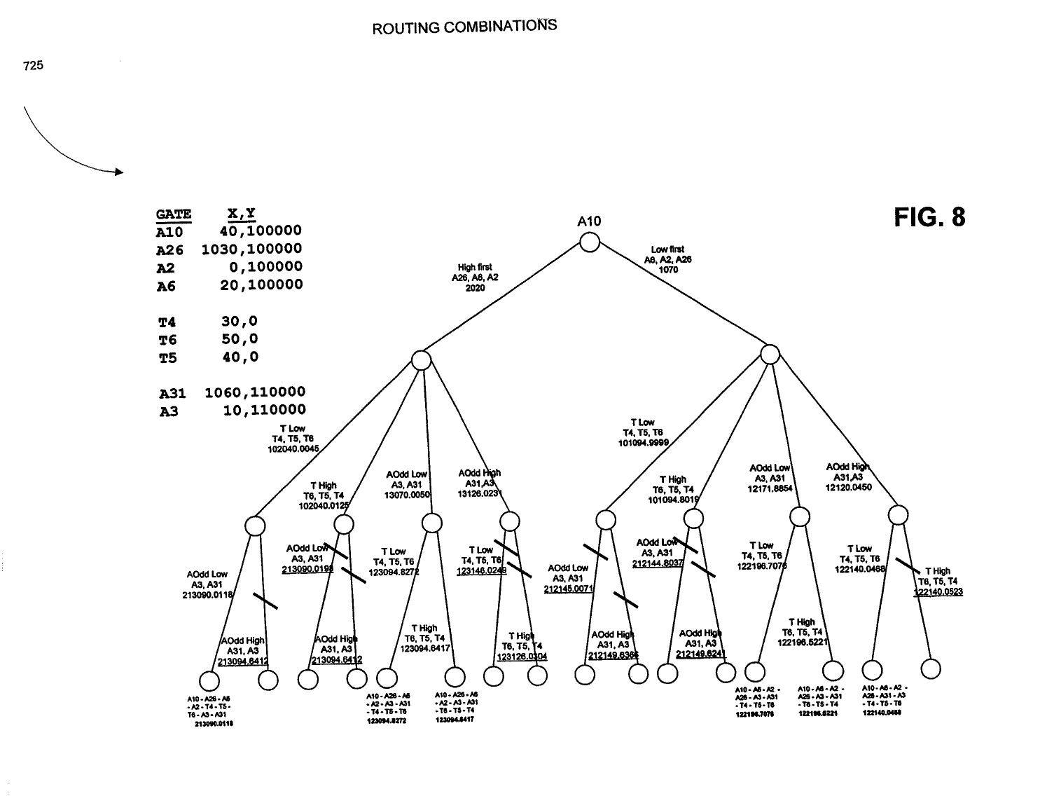

FIG. 8 provides an illustration depicting a representative example of how the routing algorithm creates a routing solution. FIG. 8 is a tree diagram showing the various possible routes for an assignment and the distance traversed with each route. This assignment has nine stops comprising 3 at the T gates, 4 on the even side of the A gates, and 2 on the odd side of the A gates. Next to each stop is its corresponding coordinates. The example starts at gate A10 and, branching to the left, the first combination adds the other A even gates in descending order producing a distance of 2020. Continuing with the left-most branch, the T gates are added producing an approximate distance of 102,040. Finally, the A odd gates can be added in ascending order producing a total approximate distance of 213,090. As FIG. 8 shows, the other possible routes are configured and their total distances calculated. Ultimately, the route with the shortest distance will be identified.

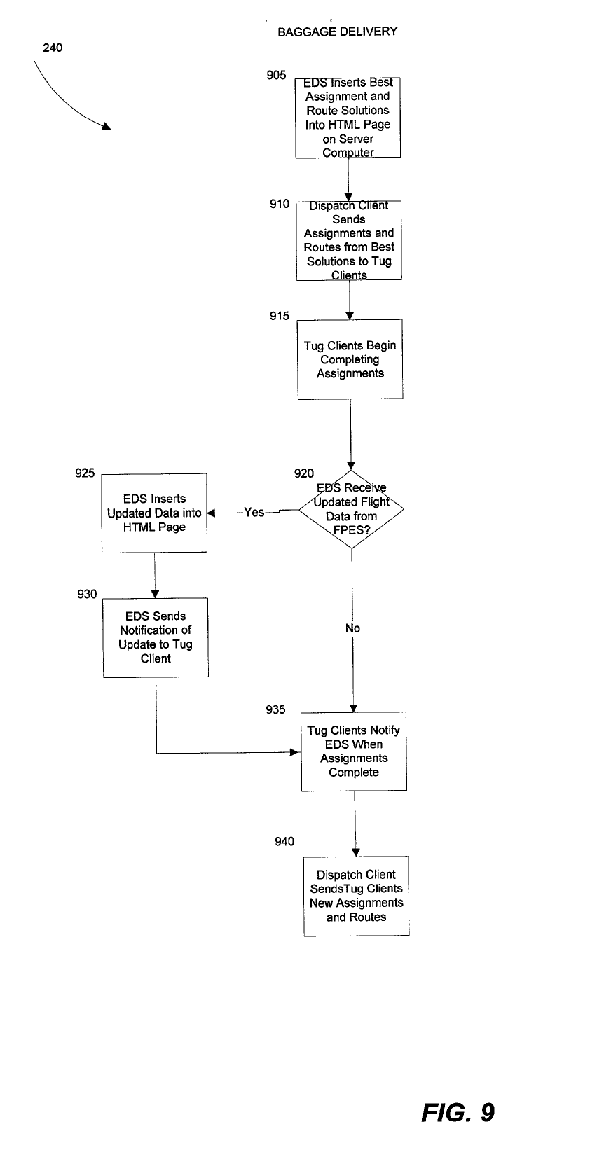

FIG. 9 sets out in greater detail the baggage delivery process as represented in step 240. In step 905, the EDS software module 135 inserts the assignments and corresponding routes into an HTML page on the server computer 130. When the inbound flight has arrived, the dispatch client 140 accesses the HTML page and sends individual assignments and routes to tug clients in step 910. In step 915 the tug clients receive the assignments and each tug driver begins completing their assignment. While the tug drivers are completing their assignments there may be changes in the connecting flight's departure time or gate location. In step 920, the EDS software module may receive updated flight data. If there is no updated data the “No” branch is followed to step 935. If there is updated flight data while the tug client is performing an assignment, the “Yes” branch is followed to step 925 where the EDS software module inserts the updated flight data into an HTML page. Notification of the update is then sent automatically to the corresponding tug client in step 930.

Another advantage of the present invention is that the tug driver does not have to waste time driving back to the dispatcher for a new assignment. As shown in step 935, when the tug driver completes an assignment, the tug client 145 can notify the EDS software module 135. In step 940, the dispatch client 430 can access the server computer 130, learn when an assignment is completed, and send a new assignment to the tug driver.

In summary, the present invention supports the efficient transfer of baggage from inbound flights to connecting flights. The invention optimizes efficiencies by evaluating the numerous variables involved in the transfer process and determining the best solution of assignments and routes for moving the baggage. The invention permits a carrier to choose which variables are more important, such as minimizing the number of tug drivers or the number of stops each tug driver makes. The invention also provides updates to assignments and routes reflecting changes in gate or baggage information. Finally, the invention reduces the amount of time required for transferring connecting baggage which in turn reduces travel delays.

Those skilled in the art will appreciate that the invention has a wide range of applications beyond air travel. For example, the invention could also be implemented to support the transfer of baggage and other items in travel by train, boat, or bus. Other than a situation with a passenger carrier, the invention could be useful in a variety of contexts where items are shipped. For example, it could be used by shipping companies for transferring items from one conveyance to another conveyance.

It will be appreciated that the present invention fulfills the needs of the prior art described herein and meets the above-stated objects. While there has been shown and described the preferred embodiment of the invention, it will be evident to those skilled in the art that various modifications and changes may be made thereto without departing from the spirit and the scope of the invention as set forth in the appended claims and equivalence thereof.

What is claimed is:

1. A method for supporting the efficient transfer of baggage from an inbound flight to connecting flights, comprising the steps of:
identifying an inbound flight to a software module operating on a server computer in a distributed computing system;
retrieving data concerning the baggage from databases logically connected to the distributed computing system and providing the data to the software module at the server;
operating the software program at the server to calculate potential assignments for baggage transfer from the data and to select an efficient solution of assignments;
operating the software program at the server to calculate potential routes for completing the assignments from the data and to select an efficient route;
distributing the selected assignments and routes from the server to clients connected to the distributed computer network; and
delivering baggage to one or more outbound flights according to the selected assignments and routes.

2. The method of claim 1, further comprising the step of notifying the software module operating on the server computer that tugs are available for delivering the baggage.

3. The method of claim 1, wherein the step of identifying an inbound flight comprises:
notifying a dispatch client of an inbound flight number for the inbound flight; and
transmitting the inbound flight number from the dispatch client to the software module operating on the server.

4. The method of claim 1, wherein the step of retrieving data from databases logically connected to the distributed computing environment comprises:
requesting flight data from a flight performance evaluation system;
if the flight data is not available in the flight performance evaluation system, requesting the flight data from an operations support system;
requesting passenger data and baggage data from a passenger information distribution system; and
if the passenger and baggage data is not available in the passenger information distribution system, requesting the passenger and baggage data from a reservation system.

5. The method of claim 1, wherein the step of calculating potential assignments to select an efficient solution of assignments comprises:
defining desired driver, baggage, and stop parameters for determining a best assignment;
creating possible assignment solutions from combinations of assignments for baggage transfer; and
calculating a cost for each assignment solution.

6. The method of claim 5, wherein the step of calculating potential assignments to select an efficient solution of assignments further comprises:
saving the solution with the lowest cost as the best assignment solution; and
presenting the best assignment solution to the dispatch client.

7. The method of claim 5, wherein the assignment solution comprises one or more assignments providing for the transfer of all connecting baggage from an inbound flight.

8. The method of claim 5, wherein the step of creating possible assignment solutions from combinations of assignments comprises:
identifying all zones of an airport concourse to which baggage must be delivered;
identifying the zone of the inbound flight as the starting zone;
either adding zones to the starting zone to create an assignment or considering the starting zone a complete assignment; and
creating additional assignments comprising either single zones or combinations of zones.

9. The method of claim 5, wherein creating possible assignment solutions from combinations of assignments comprises:
eliminating possible assignment solutions that exceed driver, baggage or stop parameters.

10. The method of claim 5, wherein the cost for each assignment solution is defined by the calculation of:
(number of drivers)*(driver cost)+
max(num. bags)−min(num. bags))*(balance cost)+
(num. of same side zones not kept together)*(pair cost)+
Σassignments ((max(num. of bags, target num. of bags)−(target num. of bags)**2*(bag cost)+
((target num. of bags−min(num. bags, target num. of bags))*(bag cost)+
(max(target num. of stops, num. of stops)−target num. of stops)*(stop cost)

11. The method of claim 1, wherein the step of calculating potential routes for completing the assignments comprises:
creating possible routing solutions from combinations of routes; and
calculating the total distances for each of the combinations of routes.

12. The method of claim 11, wherein the step of formulating various combinations of potential routes for completing the assignments further comprises:
saving the routing solution with the shortest distance as the best routing solution; and
presenting the best routing solution to the dispatch client.

13. The method of claim 11, wherein the step of calculating potential routes for completing the assignments further comprises:
identifying close connections departing shortly after the arrival of the inbound flight;
if there are close connections, beginning potential route sequences with the close connections; and
if there are no close connections, beginning potential route sequences at the inbound flight gate.

14. The method of claim 11, wherein a routing solution comprises a sequence of all of the identified gates to which baggage must be delivered.

15. The method of claim 13, wherein the step of creating possible routing solutions from combinations of routes further comprises:
identifying all gates to which baggage must be delivered and each gate's corresponding coordinates;
defining a starting gate of the route sequence at the last of the close connection gates, or if no close connections, at the inbound flight gate;
adding identified gates within the same zone as the starting gate to the routing solution;
adding the remaining identified gates; and
repeating the foregoing steps for various sequences of identified gates to create the possible routing solutions.

16. The method of claim 11, wherein the step of calculating the total distances for each of the combinations of routes is based upon coordinates assigned to each gate.

17. The method of claim 1, wherein the clients receiving the selected assignments and routes from the server are tug clients mounted on tugs operated by baggage handlers.

18. The method of claim 1, wherein the step of delivering baggage according to the selected assignments and routes comprises:
completing the assignments by baggage handlers according to the routes;
notifying the software module on the server computer via tug clients when baggage handlers have completed the assignments; and
sending new assignments and routes from the server computer to the tug clients at the dispatch client's direction.

19. The method of claim 18, wherein the step of delivering baggage according to the selected assignments and routes further comprises:
sending updated flight data to the software module; and
notifying tug clients of updated flight data.

20. A method for supporting the efficient transfer of items from an inbound conveyance to at least one outbound conveyance, comprising the steps of:
identifying the inbound conveyance;
retrieving item data describing the destination of the items on the inbound conveyance;
formulating various combinations of potential assignments for transferring the items from the item data in order to select an efficient solution of assignments;
formulating various combinations of potential routes for completing the assignments from the item data in order to select an efficient route; and
transferring the items from the inbound conveyance to the outbound conveyance according to the selected assignments and routes.

21. The method of claim 20, wherein the step of identifying the inbound conveyance comprises:
notifying a dispatcher responsible for managing the transfer of items that the inbound conveyance is approaching.

22. The method of claim 20, wherein the step of formulating various combinations of potential assignments for transferring the items comprises:
defining desired parameters for determining an efficient assignment;
creating possible assignment solutions from combinations of assignments for transferring items; and
calculating a cost for each assignment solution.

23. The method of claim 20, wherein the step of formulating various combinations of potential routes for completing the assignments comprises:
creating possible routing solutions from combinations of routes; and
calculating the total distances for each of the combinations of routes.

24. The method of claim 23, wherein the step of calculating the total distances for each of the combinations of routes is based upon coordinates assigned to each stop on the route.

25. The method of claim 20, wherein the step of transferring the items from the inbound conveyance to the outbound conveyance according to the selected assignments and routes comprises:
distributing the selected assignments and routes that direct how the items are to be transferred;
completing the selected assignments according to the routes; and
distributing new assignments and routes for the transfer of items from a new inbound conveyance.

26. A distributed computer network for supporting the transfer of baggage from inbound conveyances to connecting conveyances comprising:
a central computer system operable for managing traveler processes and transmitting passenger data, baggage data, and flight data to a server computer;
the server computer connected to the central computer system operating an electronic dispatch software module for calculating baggage assignments and routes based on the passenger data, baggage data, and flight data;
at least one tug client coupled to the server computer and operable for receiving baggage assignments and routes from the server computer and presenting baggage assignments and routes to a baggage handler; and
at least one dispatch client coupled to the server computer and operable for receiving assignments and routes from the server computer and distributing them to the tug clients via the server computer.

27. The distributed computer network of claim 26, further comprising:
a passenger information distribution system connected to the server computer and operable for transmitting passenger and baggage data to the server computer;
a flight performance evaluation system connected to the server computer and operable for transmitting flight data to the server computer; and
the electronic dispatch software module; wherein the electronic dispatch software module is operable to manipulate the passenger, baggage, and flight data to generate assignment and routing solutions.

28. The distributed computer network of claim 26, further comprising:
a flight information display system operable for notifying a dispatch client of inbound flight information.
